(19) United States
(12) Patent Application Publication
(10) Pub. No.: US 2005/0154655 A1
(43) Pub. Date: Jul. 14, 2005

(54) System and method for the sale of franchise real estate

(76) Inventors: William James Greene, Juno Beach, FL (US); Steven Michael Scott, Jupiter, FL (US)

Correspondence Address: EDWARDS & ANGELL, LLP, P.O. BOX 55874, BOSTON, MA, 02205, US

(21) Appl. No.: 10/757,106

(22) Filed: Jan. 14, 2004

(51) Int. Cl. G06F 17/60

(52) U.S. Cl. 705/30; 705/31

(57) ABSTRACT

A method and system for the sale of franchise real estate is provided in which characteristic data corresponding to the characteristics of a franchise real estate is stored in a system server. The system server is accessed from remote computers. A user accesses the system server to obtain stored characteristic data from the server by providing search criteria for selecting specific franchise real estate having the characteristic data. The server then matches the search criteria to franchise real estate having the specific characteristic data and provides the characteristic data and demographic information corresponding to the franchise real estate to a user at the remote computer upon selection of the specific franchise real estate.

### BACKGROUND OF THE INVENTION

1. Field of Invention

This invention is directed to a method of doing business, and more particularly, to the method and apparatus for the selling of franchise real estate using the Internet.

2. Background

Unlike other commercial real estate or residential real estate, the decision to purchase franchise real estate is not only a function of the aesthetics, condition and physical attributes of the property, but is also a function of location relative to other franchise properties, location as a function of street traffic, as well as overall regional demographics such as income, housing prices and shopping habits of the surrounding community.

Traditionally, franchise real estate has been sold in a manner almost identical to the sale of other real estate, utilizing commercial real estate brokers on a commission basis. The seller grants a listing to the broker. Initially, this listing is usually exclusive. The broker then researches and organizes locally available information about the property and produces sales materials regarding the property. The sales materials will usually contain a physical description of the property and some use history. The broker then mails these sales materials to its known buyers and other cold call prospects while listing the property for sale in trade publications and regional newspapers.

A buyer, usually through its own purchasing broker, makes a written offer to purchase the property through the listing broker. Price and terms are negotiated while some due diligence is performed by the buyer. Due diligence may include obtaining demographic and business related information if available. The buyer will inspect the property to confirm the claims in the sales brochures, perform a title search, determine regulatory approvals required, as well as the market conditions with respect to the property. The buyer will then secure financing and close on the property.

Some real estate brokers have established web sites to showcase their exclusive inventory of properties and listings over the Internet. However, these are merely electronic versions of the sales materials and provide little or no third party information, substantiation or verification of statements.

As a result, the prior art method for selling franchise real estate suffers from the disadvantage that it does not provide the information a buyer requires. As a result, the buyer is either making an uninformed inefficient decision or is increasing opportunity cost by conducting due diligence. Furthermore, the process, even in its online form, continues to rely on broker intervention and their additional costs and inefficiencies.

Accordingly, a method and system for the sale of franchise real estate, which overcomes the shortcomings of the prior art, is desired.

### SUMMARY OF THE INVENTION

A method and apparatus for the resale of franchise real estate includes a server establishing communications over the Internet between a seller's computer and a buyer's computer for the benefit of substantially increased information. The server stores data corresponding to the physical characteristics of the franchise property, including the asking price for the property and the address of the property. The server provides access to itself by the buyer's computer by way of a website and allows the seller to access the server to consign one or more franchise properties for sale. The server receives information about the property from the seller. The server links the buyer's computer to third party data sources having demographic and other pertinent information pertaining to each specific location of the franchise real estate to be sold. The server operates on the seller provided information and third party information to provide buyer with desired information about the property.

### BRIEF DESCRIPTION OF THE DRAWINGS

In the drawing figures which are not to scale and which are merely illustrative and wherein like reference numerals depict like elements throughout the several views:

FIG. 1 is a block diagram illustrating an online interconnection of buyers and sellers for the online sale of franchise real estate in accordance with the invention;

FIG. 2 is a flow diagram illustrating the principle steps in the sale of franchise real estate in accordance with the invention;

FIG. 3 is a flow diagram illustrating the principle steps in the buying of franchise real estate in accordance with the invention; and

FIG. 4 is an illustration of a screenshot of the franchise real estate web page.

### DETAILED DESCRIPTION OF THE PREFERRED EMBODIMENT

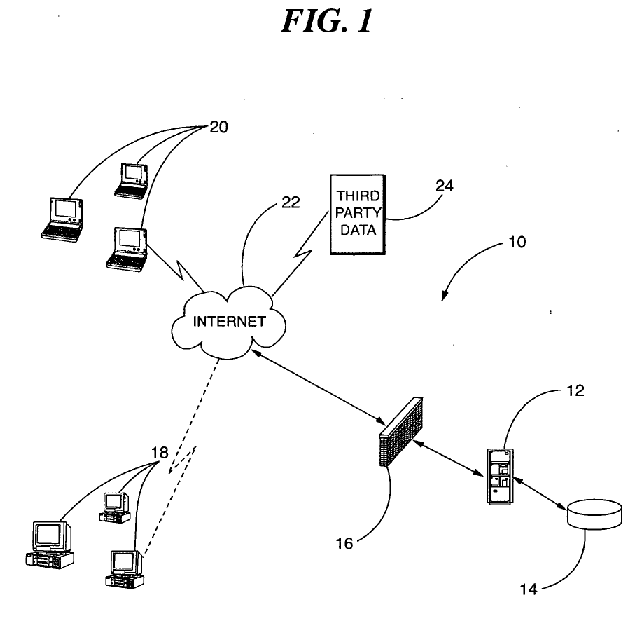

Referring to FIG. 1, an interactive system or computer network 10 for use in carrying out the methodology of the present invention for coordinating the sale of franchise real estate is provided. Computer network 10 is established, operated and maintained as known in the art. Although computer network 10 as described utilizes a global computer network, such as the Internet, it is to be understood that the methodology of the present invention could be practiced utilizing other computer communications networks capable of interactive processing of data and transmittal thereof to distant and unrelated parties.

In the preferred embodiment, a computer network 10 is a conventional computer network capable of making use of Internet applications and includes a database 14 and a server 12, disposed opposite a firewall 16 from Internet 22 as to be selectively accessible through Internet 22 by computers 18 (used by sellers) and computers 20 (used by buyers); the end users of computer system 10.

The seller computers 18 and buyer computers 20 use browsers to connect to server 12, which in connection with database 14 responds to requests and commands received from these browsers to generate an interactive franchise real estate network website through which the methodology of the present invention may be practiced. Additionally, server 12 through Internet 22 accesses third party database servers 24 which contain data thereon to enable the efficient purchase of franchise real estate as described below.

Access to the system is provided to buyers and sellers (the system users). Computer network 10 provides security measures to prevent unauthorized access as known in the art as by requiring a previously established account with a unique combination of an account number and/or password.

The data utilized to make a decision to buy franchise real estate is ever changing. Demographic information used to make an informed decision, such as current traffic patterns, changes in utility rates, area income, area home values and trends and the like can drastically change between the time the property is initially offered for sale and a buyer makes a decision to buy. Therefore, this information is continuously being updated in advance of the occurrence of a sale. Furthermore, the value of the franchise real estate changes with the change in the demographic data. Therefore, the value of a specific franchise property continuously changes over time. This type of demographic data, which changes over time for respective franchise real estate locations, is provided online by third party database servers 24 or manually updated and input to database 14.

For example, houses in a neighborhood are continuously being sold. The sale information of properties within the area are periodically published and updated. The schedules of the sold properties and the aggregate trend of the sold properties are published at third party database server 24 which are available through the Internet such as from http://www.bestplaces.com. Additionally, traffic patterns change seasonally or even month-to-month, a time period across which the property may in fact be continuously for sale. This data may be found at a third party data site 24 or a traffic count may be manually stored by date and time at database 14.

It is contemplated in one embodiment of the invention that server 12 periodically surveys third party database server 24 for changes in demographic data and stores the data in database 14 to make the data available as needed to buyer computers 20. Database 14 may be updated on a daily, weekly, monthly, quarterly, or any other periodic basis appropriate for maintaining data current enough to satisfy the needs of the buyers. It should also be understood that this data may also be input by hand (keyboard), memory devices (CDROM, flashcard, or the like) or any other known input method.

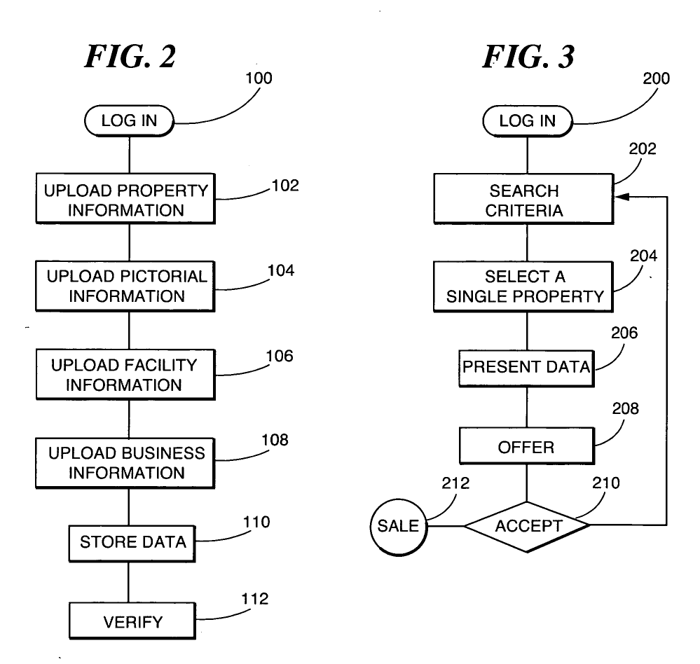

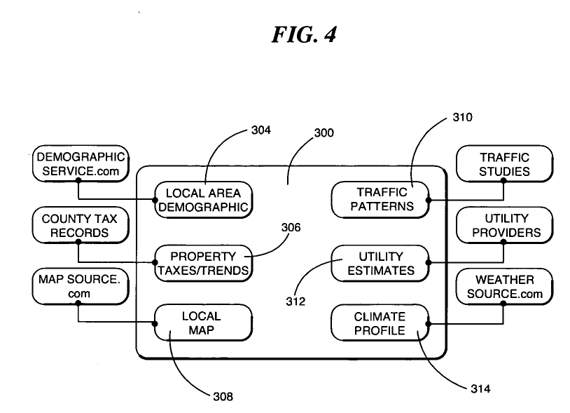

Reference is now made to FIG. 2, wherein the method for selling franchise real estate is provided. A seller logs in from remote computer 18 through Internet 22 in accordance with a step 100. Once on the system, a seller is presented with a data entry web page by server 12, at computer 18, which contains a plurality of fields into which characteristic data can be entered to be stored on database 14 concerning a particular franchise property to be offered for sale. As known in the art utilizing a graphical user interface (GUI), or other type of interactive data entry method, the seller uploads property information in a step 102. Characteristic data includes property information, facility information, business information and pictorial information. Property information is that information related to description of the property itself and may include the postal address of the location, the size of the facility, the number of floors, the construction configuration, the construction franchise, the construction type, the legal description of the property, the number of parking spaces, the square footage and the like, by way of example. In a step 104, the seller may provide pictorial information such as blueprints and digital photographs of the physical structure. This information may also include information about the surrounding environment such as distance to the nearest competitor, or the number of facilities in a similar industry within a prescribed radius.

In a step 106, facility information, which is specific information regarding the facility itself, such as the availability of drive through lanes, fire sprinklers, seating capacity, liquor license availability, whether it is a lighted lot, the type of previous use, such as guest rooms and pools (if a hotel), gymnasium equipment, lockers or showers (if a gym), security systems, showrooms and the like by way of example. With respect to restaurant facility information, by way of example, descriptions regarding specific equipment such as fryers, grease traps, fuel storage, griddles, cooler size and the like may be provided by way of example. If the franchise is an auto repair franchise, by way of example, equipment listing such as hydraulic lift, waste oil storage facilities and car wash and air compressor by way of example will be input. Lastly, in a step 108, business information such as sales history, franchise type, cost of operation and the like are uploaded by way of example.

Once all the information is uploaded, it may be stored in database 14 in an area, which cannot be accessed by buyers with their computers 20. The information may be entered by either seller or a third party or both depending upon access to the information. In a preferred embodiment, the information is verified by a third party source in a step 112. In a preferred embodiment, this may be done by the party responsible for server 12. Once the data is entered, server 12 may create other files of use to a potential buyer based upon the input information from the seller. By way of example, knowing the asking price and having the physical description information stored in database 14, server 12 may create accessible data files such as cost per square foot for the property, cost of the property per table, the ratio of cooking space to storage space or cooking space to eating space in the example of a restaurant. Furthermore, for almost any type of facility where the revenue history is provided, server 12 may calculate the revenue per square foot or revenue per table either in real time, when accessed by a buyer from computer 20, or upon entry and stored as a file in database 14 in step 110. It should be noted that the above are examples of data created by server 12, and are in no way meant to be limiting as server 12 may create data files which are third data determined as a function of one or more data stored in database 14, or as discussed below, retrieved from third party data source 24. Once the information is verified it is then made accessible online to buyers utilizing their computers 20. However, it should be known that the verification step is optional.

In a preferred embodiment, the information is uploaded across Internet 22 into database 14 by server 12. However, the information may be manually uploaded at server 12. Furthermore, the seller, knowing the format in which server 12 stores information and the minimal information required for listing at server 12, may transfer the data all at once (in batch), rather than uploading the data one field at a time.

Reference is now made to FIG. 3 in which the buyer selects franchise real estate for purchase. The buyer logs into server 12 from computers 20 through Internet 22 in a step 200. The buyer then searches for a property of interest in a step 202 in accordance with a buyer search criteria. The property may be searched by characteristic data categories such as geographical location (northeast or New York City, by way of example), identification of franchise seller (McDonald's, Chevron or Blockbuster, by way of example), industry type (restaurants, banks, gyms or hotels, by way of example), or franchise type (quick service restaurant or family sit down restaurant, by way of example) or a combination of any or all the above. By way of example, someone looking for a fast food franchise in suburb of Cincinnati, Ohio, may access database 14 either under quick service restaurants, Cincinnati, Ohio and environs, McDonald's, or any combination of the above. In response to the search, server 12 scans database 14 to determine whether any of the properties stored in database 14 have the qualities as determined from the data uploaded in the process of FIG. 2, which correspond to the criteria utilized in step 202.

If a match is found, all matches will be displayed as a list of franchise real estate properties with an indication of other information, by way of example, each property may be listed with its associated franchise, street address, and industry type or as a thumbnail picture of the property. In a step 204, utilizing a GUI, a single item may be selected for closer inspection by the buyer.

What is unique about franchise real estate is the influence of demographics on the pricing and desirability of a particular property. Furthermore, this demographic information changes over time, usually changing during the period in which the real estate is offered for sale. This information may include per capita income for the commercial and residential environment in the neighboring area, area home values and trends, traffic pattern trends and flow rates, climate, utility rates and consumption, state and local taxes and tax records, distances to major thoroughfares, distances to competing locations, locator maps and GPS coordinates and the like.

Accordingly, in step 206, when a specific property is selected, data with the property description fields and facility description fields and equipment description fields as well as business description field is provided. However, on a same screen or an individual screen 300, demographic information is made available to a potential buyer. By way of example, icons such as local area demographic 304, property taxes/trends 306, locator map 308, traffic pattern 310, utility cost estimates 312, or climate profile 314 by way of example or any other demographic data which may aid in the purchase decision may be provided. By selecting an icon utilizing a graphical user interface, the data corresponding to the data category represented by the icon will be presented to the user. For example, for local area demographic icon 304, data such as income trends, other franchises in the area, house value trends and the like would be presented to the buyer at computer 20. This may be presented by directly linking to a third party data source 24 or to data, which is stored in database 14, which is periodically updated from third party data source 24. By way of example, if the demographic data in question were the trends in neighboring property values, either commercial or residential, an icon 304 can link the buyer to data from and online demographics server source such as http://www.bestplaces.com or other real estate data sources, which may be framed as known in the art to resemble web page 300 to the user, or by taking such data from database 14. In a preferred example, to capture the most up-to-date information, icon 304 would allow direct linkage to the third party data source 24.

Similarly, if the user were interested in the property taxes and trends in the property taxes of the property or neighboring areas to develop a cost model for the ongoing business at the property, they would select icon 306 which would either link them to the county tax records if available online, or to county tax records as stored at database 14. Similarly, if a buyer wishes to obtain a better overview of the location of the facility, one would select icon 308 indicated “locator map” which in a preferred embodiment would cause server 12 to directly link the user to third party data map source 24 at a site such as www.mapquest.com which would appear at computers 20, preferably framed as the website corresponding to server 12. Again, to determine local traffic patterns, icon 310 would be selected which would link to traffic studies. To determine the cost of utilities at the site one would select the utility estimates icon 312 linking to the local utilities information page. To determine the climate profile either current, past or forecasted one would select icon 314 for click-through to the framed weather source websites such as www.weather.com. In this way, potential buyers sitting at their own computer 20 can, for the first time, obtain the necessary information for making an informed decision regarding the purchase of franchise real estate in real time at one location.

As server 12 is linked to third party data 24, it may use third party data 24 to create additional data of interest to buyers 20, in a method similar to that used in step 110 discussed above. By way of example, the local area demographic data, such as other franchises in the area discussed above, may be totaled and stored as a file of the number of competitors within a certain radius at server 12, or if the total traffic volume at the street upon which the real estate resided was known, server 12 could calculate an average traffic flow per hour. This information would be stored as a file in database 14 accessible by buyers 20.

In step 208, the buyer may then make an offer from their computer 20 to server 12, which is stored in database 14 or directly to seller's computer 18 if an e-mail address link is provided. Server 12 may now notify seller that an offer has been made by sending a message through Internet 22 to computers 18, or in an alternative embodiment, the sellers, through their computers 18, utilizing the Internet can periodically search the file of offers stored in database 14.

In a step 210, the offer is either accepted or direct negotiations can proceed between seller and buyer, either via e-mail, tracked through server 12, or offline through other communication such as telephone, facsimile or mail. This negotiation may proceed until a sale is made in a step 212.

It should be noted that in a preferred embodiment, the process can be automated. In one embodiment of the invention, user 18 may enter selection criteria for properties such as in step 202. However, the buyer search criteria can be stored in database 14 and cause server 12 to notify a buyer at computers 20 whenever a new property meeting the criteria is stored in database 14 by a seller. Furthermore, during the selection process in step 204, individual properties of interest can be tagged to be saved in a buyer personal file stored in database 14 for easy access rather than repeating steps 202-208 each time. Furthermore, server 12 can monitor the tagged properties in database 14 and indicate to user 18 when such tagged properties have in fact sold, or for which an offer has been made. Notification can be across Internet 22 to computers 18, or by other computer-generated communication such as an e-mail to a pager, an automated telephone contact or the like.

While there have been shown, described and pointed out novel features of the present invention as applied to preferred embodiments thereof, it will be understood that various omissions and substitutions and changes in the form of details of the disclosed invention may be made by those skilled in the art without departing from the spirit and scope of the invention. It is the intention therefore, to be limited only as indicated by the scope of the claims appended hereto. It is also to be understood that the following claims are intended to cover all of the generic and specific features of the invention herein described and all statements of the scope of the invention, which as a matter of language might be said to fall therebetween. In particular, the invention should not be construed as being limited to the use of specific Internet structures, specific screens or web pages, specific prompts or specific data as disclosed herein.

1. A method for the sale of franchise real estate comprising the steps of:
storing characteristic data corresponding to the characteristics of the franchise real estate in a system server;
allowing a user to access said system server to obtain the stored characteristic data from said server, the user providing a search criteria for selecting specific franchise real estate having specific characteristic data;
selecting specific franchise real estate having the specific characteristic data; and
providing characteristic data and demographic information corresponding to the specific franchise real estate to said user at a computer upon selection of said specific franchise real estate.

2. The method of claim 1, wherein said server provides said demographic data by linking said user to a third party data source having said demographic information.

3. The method of claim 1, further comprising the step of said server periodically obtaining demographic information from a third party data source and storing said demographic information at a database operatively coupled to said server.

4. The method of claim 1, wherein said characteristic data includes one of property information, facility information, business information and pictorial information.

5. The method claim 1, wherein said demographic information includes at least one of property taxes, traffic patterns, utility cost estimates and climate profile.

6. The method of claim 1, wherein said user provides a search criteria by identifying certain characteristics, said server mapping said characteristics to characteristic data stored at said system server, determining which respective franchise real estate corresponds to characteristic data matching said user selected characteristics and providing and identifying said respective franchise real estate to said user.

7. The method of claim 1, further comprising the steps of storing said search criteria at said system server, periodically comparing said search criteria to said stored characteristic data; and notifying said user when said search criteria matches said stored criteria.

8. The method of claim 1, wherein said specific characteristic data includes at least a financial data and an area data and further comprising the steps of creating a third data which is a function of said financial data and an area data, and allowing a user access to said system server to obtain said third data.

9. The method of claim 1, further comprising the steps of creating a third data which is a function of characteristic data and demographic data and allowing a user access to said system server to obtain said third data.

10. A system for the sale of franchise real estate comprising:
a system server; and
a computer communicatively coupled to said system server, said server storing characteristic data corresponding to characteristics of the franchise real estate, said computer communicating with the system server to provide a search criteria having a specific characteristic data, said server matching said search criteria and the characteristic data and identifying matches between the search criteria and a specific franchise real estate having the characteristic data of the search criteria and providing demographic information corresponding to the specific franchise real estate to said computer.

11. The system of claim 10, further comprising a third party data source, said server being coupled to said third party data source and linking said computer to said third party data source to obtain the demographic information.

12. The system of claim 10, wherein the server periodically obtains the demographic information from a third party data source and further comprising a database operatively coupled to said server and said server storing said demographic information at said database.

13. The system of claim 10, wherein said characteristic data includes one of property information, facility information, business information and pictorial information.

14. The system of claim 10, wherein the demographic information includes at least one of property taxes, traffic patterns, utility cost estimates and climate profile.

15. The system of claim 10, wherein said specific characteristic data includes at least a financial data and an area data and said system server creates a data which is a function of said financial data and area data and allowing a user access to said system server to obtain said third data.

16. The system of claim 10, wherein said system server creates a third data which is a function of at least one of characteristic data and demographic data and allowing a user access to said system server to obtain said third data.
